(19) United States
(12) Patent Application Publication
(10) Pub. No.: US 2026/0087383 A1
(43) Pub. Date: Mar. 26, 2026

(54) META-LEARNING WITH DIVERSE TASKS

(71) Applicant: THE TORONTO-DOMINION BANK, TORONTO (CA)

(72) Inventors: Jesse Cole Cresswell, TORONTO (CA); Yi Sui, Newmarket (CA); Keyvan Golestan Irani, TORONTO (CA); Maksims Volkovs, TORONTO (CA); Wei Cui, Richmond Hill (CA)

(21) Appl. No.: 19/333,295

(22) Filed: Sep. 18, 2025

Related U.S. Application Data
(60) Provisional application No. 63/697,834, filed on Sep. 23, 2024.

(51) Int. Cl. G06N 5/04

(52) U.S. Cl. CPC G06N 5/04

(57) ABSTRACT

Meta-learning models are improved for few-shot learning of unseen tasks by improving task diversity of training data used for training the meta-learning model. A task diversity score may be determined between a pair of tasks that partition a domain into respective classes. The respective classes are paired and scored to determine similarity between class pairs and subsequent task diversity scores. Diverse tasks may be generated with unsupervised analysis of the domain by determining disentangled latent features of the data samples. Each latent feature may then be considered a task with classes based on a clustering of the data samples based on the feature values of the respective latent feature. The classes are then used as training task labels for the data samples and sampled from to generate diverse tasks for the meta-learning model.

This application claims the benefit of U.S. Provisional Application No. 63/697,834, filed on Sep. 23, 2024, the contents of which is hereby incorporated by reference in its entirety.

### BACKGROUND

This disclosure relates generally to improving meta-learning models and more particularly to improving meta-learning models by training a meta-learning model with diverse tasks.

Meta-learning models aim to learn characteristics of a data domain that enables the meta-learning model to effectively classify a query based on a small number of examples of each class, called “supports,” that are included with the query as an input to the meta-learning model. Ideally, the learned parameters of the meta-learning model enable it to characterize the query with respect to the example supports due to learned aspects of the data domain obtained from the training data for the meta-learning model.

In many cases, however, the training tasks for a meta-learning model may not present significantly different tasks for the meta-learning model, such that the meta-learning model does not effectively learn generalizable aspects of the data domain that can be applied effectively to new tasks. For example, many benchmarks for meta-learning models in imaging include several tasks that effectively perform object classification (e.g., a task for classifying “cat” or “dog” in an image and another task of classifying “cow” or “rabbit”). As a result, meta-learning models trained with these types of tasks may underperform when applied to different task categories and the models may fail to learn more complex aspects of the data domain.

### SUMMARY

To improve meta-learning model application to a wider range of potential tasks in a domain, the meta-learning model is trained with training data that promotes task diversity in the training data.

Particularly, embodiments of the invention include an approach for evaluating task diversity between a pair of tasks, as measured in the data sample input domain. By evaluating in the input domain, the “native” aspects of the data samples may be captured to determine diversity with respect to partitions of the respective classes of each task. Particularly, each task may have a respective set of classes for the input domain. A set of class pairs is identified including a class from each task, where each class pair includes similar classes between the tasks. The similarity between each class pair is scored, for example, as an intersection-over-union of the data samples in the respective classes. An overall diversity score for the tasks may then be determined by combining the similarity scores of the class pairs (e.g., as an average). The task diversity score may then be used to evaluate task pairs and to select or otherwise affect tasks used to train a meta-learning model. As one example, the task diversity score may be used to select or set parameters for a task generation algorithm by comparing resulting tasks from the generation algorithm.

As one approach to generating diverse tasks, tasks may be generated for training a meta-learning model by generating disentangled latent features for the data samples of a domain. Each disentangled latent feature may be used to construct respective training tasks by clustering the data samples according to the latent feature values and treating the clusters as classes for the training task. The training tasks may be generated by selecting data samples for training task classes (as supports or queries) from the clusters. These training tasks may be highly diverse because they are generated from the disentangled latents, enabling the meta-learning model to effectively learn diverse aspects of the input domain.

### BRIEF DESCRIPTION OF THE DRAWINGS

FIG. 1 illustrates example components of a meta-learning system for training meta-learning model, according to one or more embodiments.

FIG. 2 shows an example of a meta-learning model applied to meta-learning inputs for different tasks, according to one or more embodiments.

FIG. 3 is an example for training a meta-learning model based on a set of domain training data, according to one or more embodiments.

FIG. 4 shows an example of adapting a meta-learning model to a particular task, according to one or more embodiments.

FIG. 5 shows example task diversity for training data in a domain for different tasks, according to one or more embodiments.

FIG. 6 shows an example process and data flow for determining a diversity score for tasks used to train a meta-learning model, according to one or more embodiments.

FIGS. 7A-B show a dataflow for generating a diverse set of tasks for training a meta-learning model, according to one or more embodiments.

FIG. 8 shows an example method for training and applying a meta-learning model, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

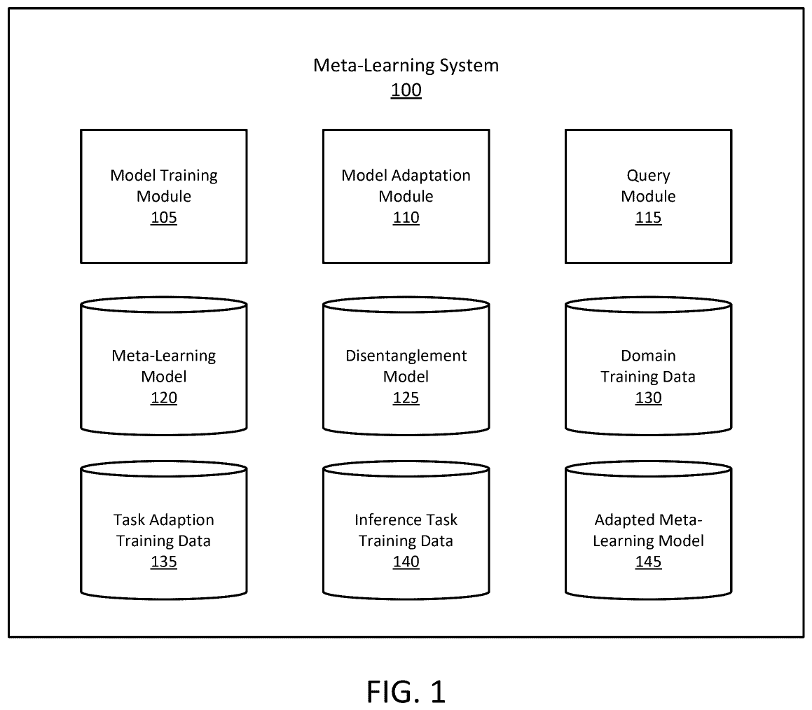

FIG. 1 illustrates example components of a meta-learning system 100 for training meta-learning model 120, according to one or more embodiments. The meta-learning system 100 includes various modules and data stores for training and applying a meta-learning model. In general, a meta-learning model 120 is trained to perform “few-shot” classification, such that the meta-learning model 120 receives examples of the classes relevant to a particular task and determines whether a particular query belongs to one of the classes. The meta-learning system 100 trains the meta-learning model 120 on a diverse variety of “tasks,” such that the meta-learning model 120 aims to learn parameters for classifying the query based on the provided supports.

The meta-learning model 120 may be trained on various data samples from a particular domain across many “tasks,” such that the meta-learning model 120 is intended to be capable of effectively evaluating a query for many different types of tasks that differ from the tasks used to train the meta-learning model 120. That is, learning to classify queries based on many different types of tasks (along with the related supports) enables the meta-learning model 120 to determine relevant aspects of data samples in the domain and classify queries with respect to provided task supports without extensive training on particular tasks (and, in some cases, with no additional training for specific tasks). As such, the meta-learning model 120 may be able to evaluate a query for many different types of tasks expected to be generally capable of evaluating a query for an arbitrary task. As discussed further below, a model training module 105 may improve training of the meta-learning model 120 by increasing the diversity of tasks used to train the meta-learning model 120. The task diversity may be measured by a task diversity score that measures the level of diversity between different tasks and may be used to select training tasks that most-increase task diversity when training the meta-learning model 120. In addition, the model training module 105 may automatically generate tasks for a set of domain training data 130 that enables diversified tasks to train the meta-learning model 120 based on the character of the domain training data 130 and without requiring external labels. These and additional aspects of the meta-learning system 100 are further discussed below.

The components of the meta-learning system 100 in various embodiments may be deployed on one or more systems and may be performed at different computing devices. For example, while shown in FIG. 1 as part of a single meta-learning system 100, in some embodiments, the meta-learning model 120 may be trained on one computing system, then sent to another computing system for adaptation as an adapted meta-learning model 145. Similarly, the meta-learning model 120 or adapted meta-learning model 145 may be deployed to one or more additional systems for responding to queries (e.g., used for inference) using the model.

As an overview, the model training module 105 may use a plurality of data samples forming a set of domain training data 130 of a domain for training the meta-learning model 120. The domain (e.g., a data sample input domain) is the type of data that may be used for the meta-learning model 120. Particular data samples (e.g., data points or instances) of the domain are data items drawn from the domain. For example, in the image domain, a particular image is one “data sample” that may be used with the meta-learning model 120. The meta-learning model 120 may include individual data samples as a data sample to be queried or as the “support” for classes for the particular task to be evaluated by the meta-learning model. In general, data samples from the domain may also occupy only a portion of the possible range of values for the domain. For example, a domain of images having a resolution of 256×256 with three color channels may enable data samples that could have any color value at each pixel position within an image, but actual data samples typically occupy a portion of the possible space.

Although the examples discussed below generally relate to images, additional domains with additional types of data samples may be used in various embodiments, including tabular data (e.g., a set of fields/data structure that may have independent value ranges and unknown relationships between the fields), text (e.g., represented as one or more embeddings of textual tokens), audio, and other data domains.

The model training module 105 trains parameters of the meta-learning model 120 with a set of training tasks. The model training module 105 may automatically generate a set of training tasks for training the meta-learning model 120 with unsupervised analysis of the data samples. As discussed further below, the model training module 105 may determine disentangled latent features of the data samples, for example, with a disentanglement model 125, and use the latent features to construct training tasks for the domain based on the domain training data 130 without requiring supervised task labels.

The meta-learning model 120 may also be further adapted for a specific task as an adapted meta-learning model 145 by a model adaptation module 110. This may include further training of the meta-learning model 120 for application to a particular task of interest. Where the meta-learning model 120 may be generated for domain training data 130 including a wide variety of data samples that may be gathered from a number of different data sets for the domain, a set of task adaption training data 135 may include data samples for a specific task of interest, permitting the meta-learning model 120 to be further trained with respect to the particular task of interest to further inference. In addition, as the adapted meta-learning model 145 corresponds to refined parameters of the meta-learning model 120 for a particular task, in some situations, different adapted meta-learning models 145 may be created for each particular task to be used in inference based on the “general-purpose” meta-learning model 120.

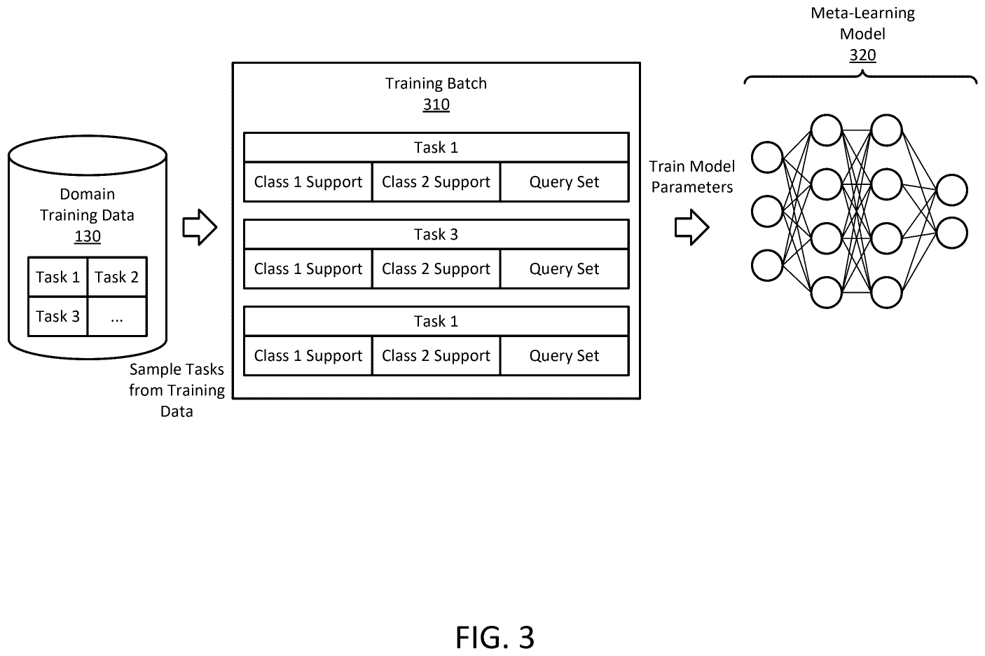

Additional details regarding training and adaptation of the meta-learning model are provided below, particularly with respect to FIG. 3 and subsequent Figures.

In some embodiments, the meta-learning model 120 may be applied directly for a task, relying on the trained parameters of the meta-learning model 120 and the support examples in the meta-learning model input to inform the model evaluation of a query.

The meta-learning system 100 may also include a query module 115 that receives and processes queries for the meta-learning model 120 or (when available) a relevant adapted meta-learning model 145. The query module 115 receives a query request specifying one or more data sample queries in the domain along with a task to be evaluated for the data sample. In some embodiments, the task may be defined by a set of support examples to be used for evaluating the query request. In additional examples, the query module 115 may obtain support examples for the query from a relevant set of inference task training data 140. The inference task training data 140 may include a number of examples of each class relevant to an inference task. The query module 115 may select (e.g., by randomly sampling) a number of support examples for each class of the task to generate a meta-learning model input for the queried data sample. The query module 115 applies the meta-leaning model input to the meta-learning model 120 (or adapted meta-learning model 145) to obtain predictions for the query and may return the predictions to the requesting system.

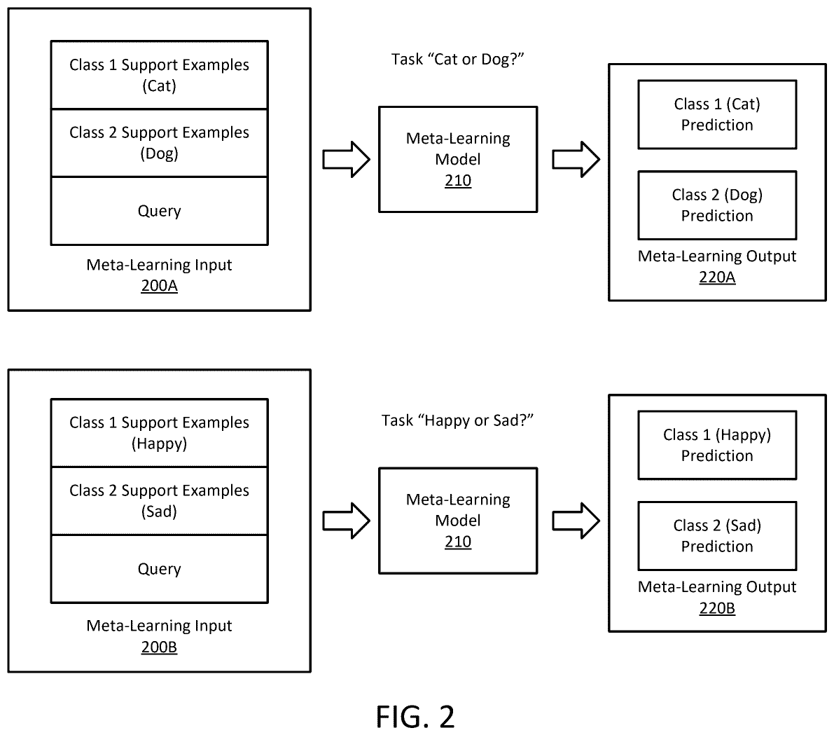

FIG. 2 shows an example of a meta-learning model 210 applied to meta-learning inputs for different tasks, according to one or more embodiments. The meta-learning model 210 is trained to determine class predictions for a query based on a set of support examples for each class. As such, different “tasks” may be defined by the different sets of data samples included as the support examples in a meta-learning input 200. In this example, a first task corresponds to determining whether the query is classifiable as a cat or a dog, and a second task corresponds to determining whether the query is classifiable as a happy or sad image. Although both tasks relate to evaluating the image domain, successfully classifying these different tasks requires the meta-learning model 210 to assess very different aspects of the data samples.

Rather than learn a representation or encoding of the input data sample and learn a predictive layer for a task based on the representation, the meta-learning model 210 assesses the query based on the support examples included with the meta-learning input 200. As such, for the task to determine whether an image depicts a cat or a dog, the corresponding meta-learning input 200A includes a query data sample to be evaluated and a set of class supports for each of the classes to be evaluated by the meta-learning model 210. For this task, the support examples are images representing the “cat” and “dog” to be evaluated for the task. As such, the meta-learning input 200A for the first task includes support examples for class 1 that are images of a cat and the support examples for class 2 that are images of a dog. To evaluate the meta-learning input 200A for this first task, the meta-learning model 210 uses its parameters to evaluate the query with respect to the support examples to determine a meta-learning output 220A that may include one or more class predictions related to the classes in the meta-learning input 200A (i.e., predictions for a “cat” and a “dog”).

Similarly, for the second task relating to “happy or sad,” the meta-learning input 200B includes a set of support examples for class 1 including data samples for “happy” and a set of support examples for class 2 including data samples for “sad” along with the query to be evaluated. The meta-learning model 210 generates related outputs for the meta-learning output 220B. Particularly, training of the meta-learning model 210 aims to enable the meta-learning model 210 to perform well at predicting outputs 220 based on many different types of “tasks” that may be defined by the different class support examples in the meta-learning input 200.

FIG. 3 is an example for training a meta-learning model 320 based on a set of domain training data 130, according to one or more embodiments. To train the meta-learning model 320 to effectively learn aspects of the data samples in the domain for a variety of different tasks, the set of domain training data 130 with a variety of different task labels is used to construct a training batch 310. The model training module 105 may sample tasks and related data samples associated with classes for the task, such that each task may include a set of support examples for each class along with a query set for training the meta-learning model 320. The query set may include a number of data sample queries and, for training the model, may include labels with respect to the related task, such that the output by the meta-learning model 320 during training can be evaluated with respect to the query label and used to determine parameter updates based on a loss or object function for the training process. The training process may assemble multiple training batches 310 for training the meta-learning model 320 that may be applied across various training epochs as the meta-learning model parameters are updated during the training.

The meta-learning model 320 may have various architectures in different embodiments and according to the particular data domain of the data samples being evaluated. For example, the meta-learning model 320 may include various computer modeling layers with learnable parameters implementing different types of processing at each layer, such as convolutional layers, recurrent layers, pooling layers, activation layers, fully-connected layers, skip connections, and so forth, that may vary in different embodiments. In general, the meta-learning model 320 may include parameters that enable evaluation of the query with respect to the class support examples to generate predictive outputs corresponding to the supported classes. In some embodiments, training of the meta-learning model 320 may include two stages, first to train parameters applicable to a plurality of tasks, second to train (“adapt”) model parameters for a specific task. A first training stage (as shown in FIG. 3) that may be based on a plurality of different “meta-learning tasks” to learn a set of the model's meta-parameters may be shared across many different tasks. The meta-parameters may represent, for example, parameters that may be used to discern relevant aspects of each data sample for evaluation with the different class supports. The model training module 105 may train parameters of the meta-learning model 320 using the tasks of the training batch 310 with any suitable training methodology given the domain and model architecture. In some embodiments, the loss function for training parameters of the meta-learning model 320 is a cross-entropy loss on the model outputs for the query data samples (e.g., based on a task label in the domain training data 130).

The various architectures and training methodologies for the meta-learning model 320 may be used in various embodiments. For example, for the imaging domain, the meta-learning model 320 may include a ResNet or other image-processing backbone. As various examples, the meta-learning model 320 and meta-learning training processes may be based on Model-Agnostic Meta-Learning (“MAML”). As another potential model and training paradigm for the meta-learning model 320, the model architecture may also implement ensemble learning, such that the model architecture implements a mixture of models (“mixture of experts”), such that the different constituent models may evaluate the inputs in various ways and the meta-learning model effectively learns when to use evaluations from the different models in the mixture. In general, model architectures and training approaches that effectively learn from high task diversity may be suitable for the meta-learning model as discussed herein.

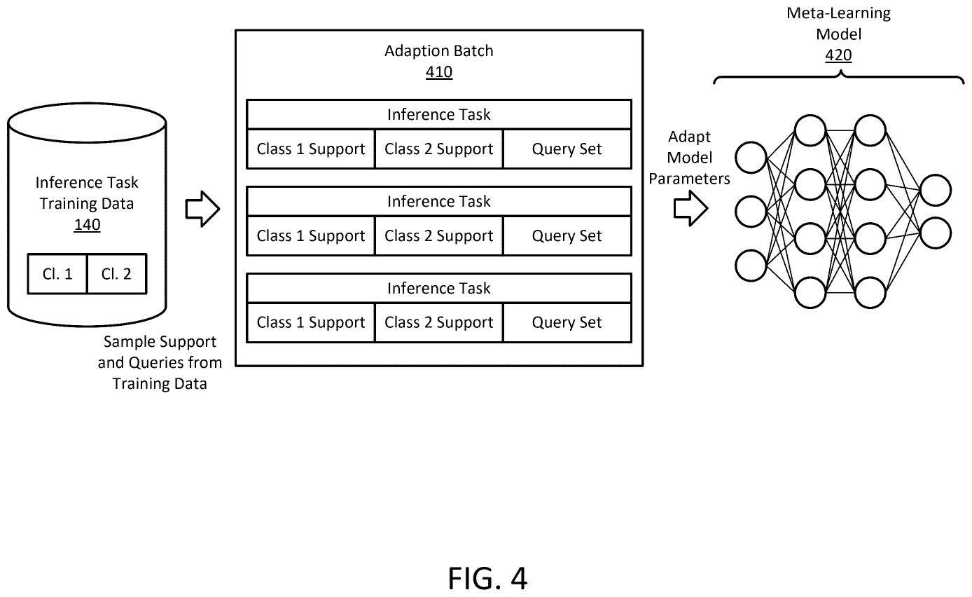

FIG. 4 shows an example of adapting a meta-learning model 420 to a particular task, according to one or more embodiments. As noted above, in some examples, the training process may include training meta-parameters of the meta-learning model with respect to various tasks in a first training step, which may yield a general meta-learning model that may be relevant to many different tasks in the domain (e.g., a trained meta-learning model 120). The second training step may then adapt the model for a specific task (e.g., as adapted meta-learning model 145).

To adapt the model, an adaptation batch 410 for the task generates training inference tasks from the set of inference task training data 140 and adapts model parameters for the meta-learning model 420 to reduce an error with respect to the inference tasks in the adaptation batch 410. Because the adaptation batch 410 relates to a specific task for inference, training of the meta-learning model 420 for adaptation to the inference task may train task-specific parameters of the meta-learning model 420. In some embodiments, the adaptation for a task only modifies the task-specific parameters of the meta-learning model 420 and holds the meta-learning parameters constant.

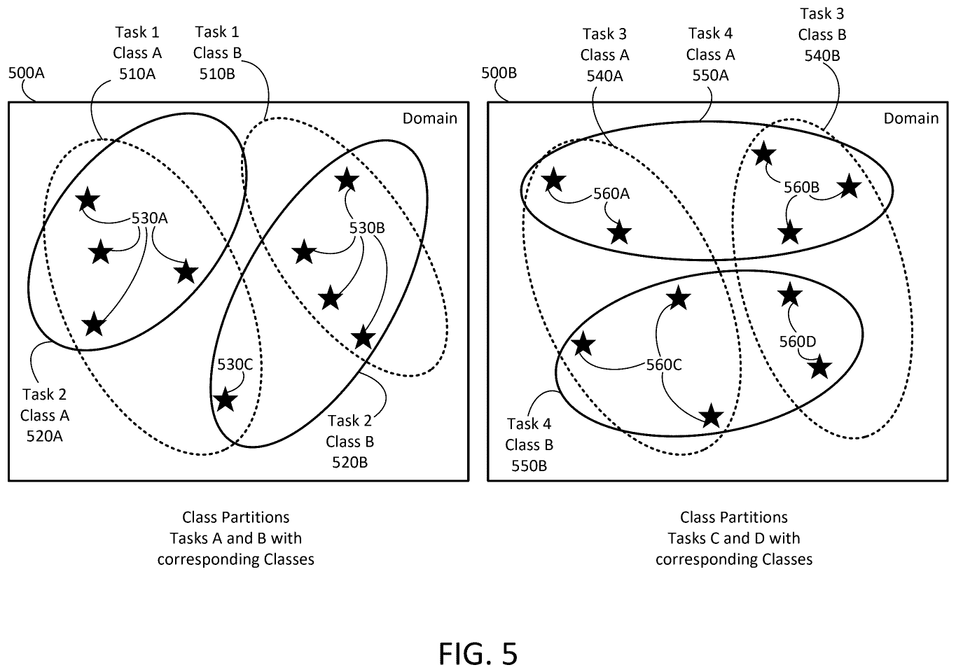

FIG. 5 shows example task diversity for training data in a domain 500 for different tasks, according to one or more embodiments. The performance of a meta-learning model may be affected by the task diversity of the tasks used to train the meta-learning model. Typically, training the meta-learning model with tasks having a high diversity relative to one another may improve meta-learning model performance and the likelihood that it may perform well for an arbitrary task that may have unknown similarity to the training data for the meta-learning model. As discussed below, a task diversity score may be calculated between tasks to characterize the similarity of the tasks in the data domain. FIG. 5 shows a domain 500 with a set of data samples that represent different “positions” in the domain 500 that correspond to different values of the respective inputs for the data samples.

A first domain 500A shows a set of data samples 530 (represented by stars) for a first pair of tasks with corresponding class labels. The class labels are shown in FIG. 5 as a cluster or partition of the first domain 500A, indicating the regions of the domain that may be characterized as each respective class.

For the first pair of tasks shown in domain 500A, the first pair of tasks includes a first pair of tasks each having respective classes A and B. The first task partitions the data samples into a cluster 510A for class A of the first task and a cluster 510B for class B, and the second task partitions the data samples into a cluster 520A for class A and a cluster 520B for class B. In this example, the regions shown by the clusters indicate the portions of the domain that may be characterized by the respective tasks for the respective classes. That is, in some embodiments, the tasks may be determined in a way that can be used to partition the domain, such as by clustering, into different classes for a task. This may be performed by unsupervised analysis (e.g., without prior existing class labels as discussed in one embodiment below) or may be performed with prior labels that designate classes for the tasks in which multiple data samples may be labeled with class membership for different tasks, or task labels for some data samples may be inferred for other data samples based on a suitable algorithm, such as clustering based on the labeled data samples.

In the first pair of tasks shown in domain 500A, the different tasks have relatively low task diversity-both tasks have significant overlap in the respective class partitions for the set of data samples. For example, data samples 530A are included in class A for both task 1 and task 2, while similarly data samples 530B are included in class B for both task 1 and task 2. Only data sample 530C is included in class A for task 1 and class B for task 2.

A second pair of tasks having significantly higher task diversity is shown in domain 500B. Domain 500B shows class partitions based on clustering for tasks 3 and 4. Particularly, task 3 has class A partitioned with cluster 540A and class B partitioned with cluster 540B. Task 4 has class A partitioned with cluster 550A and class B partitioned with cluster 550B. Tasks 3 and 4 have significantly higher task diversity, as each of the different tasks have class labels that more significantly diverge from one another. Thus, while tasks 3 and 4 both have data samples 560A in class A, more data samples are in other classes than are in common between class A: data samples 560B are in class B for task 3, and data samples 560C are in class B for task 4. Similarly, only data samples 560D are in common for class B of each task.

The additional task diversity of the second pair of tasks (tasks 3 and 4 in domain 500B) may indicate that these tasks may be better tasks for training the meta-learning model, as the model's capacity to learn distinctions between these different tasks may require the model to effectively learn more varied aspects of the training domain. By focusing the task diversity on partitions of the data domain, the task diversity may be evaluated in a way that ensures the meta-learning model may capture different types of latent characteristics of the data domain without distortions that may occur in other methods (e.g., when measuring diversity in an embedding space).

To evaluate different tasks for training the meta-learning model, a task diversity score may be evaluated for the different class memberships of the different tasks. The task diversity score may evaluate the task diversity of a pair of tasks as applied to the input data domain (e.g., the domain of the data samples that may form the query and class supports for the meta-learning model). By evaluating and accounting for task diversity for the meta-learning model, the training can expressly benefit from the task diversity to boost the capability of the model to be applied (or adapted) to many different types of downstream tasks. In addition, this enables different embedding spaces or labeling schemes to be used to construct tasks, such that the evaluation of task diversity may be performed in the data domain without requiring reference to any particular embedding space.

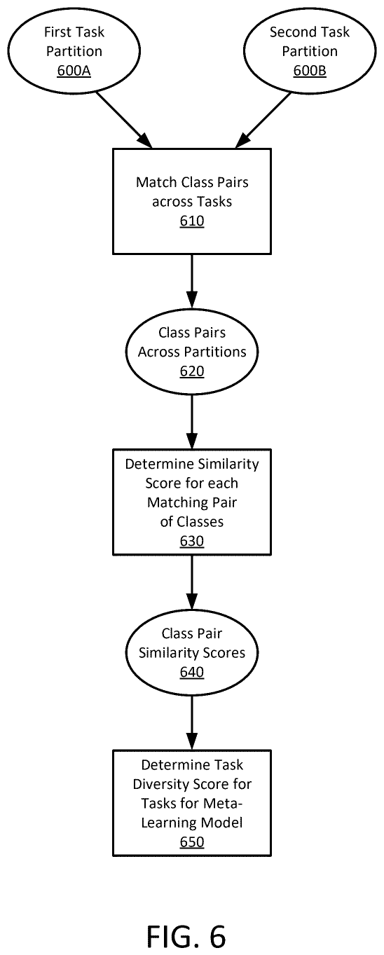

FIG. 6 shows an example process and data flow for determining a diversity score for tasks used to train a meta-learning model, according to one or more embodiments. This data flow and process may be performed, for example, by a model training module 105 when training a meta-learning model as discussed above. Initially, the diversity score for a pair of tasks may be evaluated based on the class membership of the tasks, which may be assigned different data samples of the domain for different tasks. To evaluate the task diversity, the task class labels may be converted to class partitions associated with each task, such that each task represents a different partition of the input domain. In some approaches for generating task labels, the data samples may automatically be partitioned to tasks, such as the approach for generating tasks further described below. Because meta-learning is often applied to situations with relatively few data labels (e.g., for few-shot learning across different tasks), class partitions may in some embodiments be extrapolated from a limited number of class support examples.

Accordingly, to evaluate task diversity across a pair of tasks, each task may be described by respective class partitions: a first task partition 600A and a second task partition 600B. Each task partition 600A-B has a respective set of classes that are associated with data samples in the domain as shown in FIG. 5. In some instances, the task partitions 600A-B may have a different number of classes in each class partition. To evaluate the task diversity between the associated tasks, the classes of the respective partitions are compared to identify pairs of classes that “most match” between the tasks and evaluates the level of similarity between the class pairs. By trying to optimize the class pair similarity, the resulting task diversity may then be determined based on the class pair similarity, such that pairs of tasks with lower class pair similarity may be considered to have more diversity.

In further detail, the class pairs between the task partitions 600A-B are matched 610 to select pairs of classes (e.g., class 1 from the first task paired with class 3 from the second task) that have the highest similarity with respect to the associated data samples of each class (from the respective partitions). In addition, in various embodiments, each class of each task may be selected only once for pairing the class with a class of the other task. The classes may be matched with various methods in varying embodiments and may be a bipartite matching, such that each class (of each task partition) is paired with, at most, one other class of the other task. In some circumstances, not all classes may be assigned a class pair, for example when the number of classes differ across the task partitions, or when a particular class has data samples in common only with classes (of the other task) that have already been matched or that match more strongly with another class.

To evaluate pairs of classes for matching 610 the class pairs, the pairs may be evaluated based on the data samples of the respective classes, such as the number of data samples in common between the classes (e.g., the “intersection” of data samples between the class pairs of the different partitions). As an additional alternative, the pairs of classes may be evaluated using a similarity score between the pair of classes. For example, the similarity score between the pair of classes may describe the relative similarity of data samples in the domain for the classes. In one embodiment, the similarity score may be determined based on the “intersection over union” (IoU) of the classes with respect to the data samples in the respective classes. The IoU may be determined as the number of data samples at the intersection of the respective classes (i.e., the data samples that are identified as being in both classes) and dividing by the number of all data samples associated with either of the classes. As such, the IoU represents a proportion of the data samples that are jointly within both classes relative to the total number of data samples labeled by the classes. As such, when there are no data samples in common, the IoU is zero (the intersection is zero) and as the number of data samples increases that belongs to one class exclusively, the “union” increases and decreases the proportion of total data samples in common.

This evaluation of class similarity is then used to match 610 class pairs across the task partitions 600A-B. The matching between classes may be performed based on the evaluation in various ways. As one example, the matching 610 may evaluate all possible class pairs across the task partitions to optimize the overall class pairing between the tasks. In another example, the matching 610 may use a greedy algorithm, for example, that sequentially processes the classes for one task and selects the best-matching class (that is not yet paired) in the other task.

After selecting the class pairs across the task partitions 620, a similarity score may be determined 630 for each class pair that describes the similarity of the class pairs with respect to the respective data samples in the domain. As one example, the similarity score may be an intersection-over-union for the class pairs as discussed above. The similarity between the class pairs may be determined in alternate ways in varying embodiments.

After determining the class pair similarity scores 640, a diversity score for the pair of tasks is determined based on the class pair similarity scores. As noted above, the class pairs are generally constructed to identify the class pairs across the tasks that most-match the different class partitions represented by the tasks, such that the class similarity scores represent similar class pairings across the tasks. When the tasks are highly similar, the class pair similarity scores thus should be relatively high, and when the tasks are highly dissimilar, the class pair similarity scores should be relatively low (i.e., the similarity scores are low despite the pairs representing the “most-similar” pairs that can be made across the class partitions).

An overall task diversity score may thus be determined 650 from the class pair similarity scores 640 in a variety of ways that combine the scores of the different class pairs. As one example, the class pair similarity scores 640 are averaged to determine 650 the task diversity score between the pair of tasks. In other examples, additional statistical approaches may be applied to the class pair similarity scores 640, for example, to remove outliers or to determine the task diversity score as a median or percentile of the class pair similarity scores. In some embodiments, a lower diversity score may represent higher task diversity (e.g., when averaging the class pair similarity scores of low-similarity class pairs). In additional embodiments, the task diversity score may be inverted relative to the similarity scores, such that a higher task diversity score represents a higher task diversity. For example, in one embodiment, the class pair similarity scores may be determined by the IoU of the respective classes and the diversity score may be determined as one minus the average of the class pair similarity scores. Although various embodiments may differ in the scoring function for the task diversity, for convenience of discussion in the remainder of this disclosure, a relatively high task diversity score indicates a higher task diversity. As such, the ensuing discussion applies equally to equivalent evaluations of task diversity in which a “lower” task diversity score indicates increased task diversity.

The task diversity score may then be used in various ways to modify training data for training of the meta-learning model. The task diversity score between two tasks may be used in various embodiments to evaluate and select tasks for training of the meta-learning model. For example, different data samples may be included in the training data set for the domain or the task labels used for the data samples of the domain. As such, training of the meta-learning model may be affected by the task diversity scores.

In various embodiments, the task diversity score may also be evaluated for pairs of tasks to determine task diversity scores between different training data sets that may have different tasks. For example, tasks may be selected for training the meta-learning model based on the task diversity score. For example, a task diversity score may be evaluated between a set of tasks currently in a training data set and a task (or set of tasks) to be added to the training data set. As one example, the additional task (e.g., as an additional set of class labels for data samples) is added to the training data set when the additional task adds a minimum amount of task diversity to the set of existing training data. For example, the additional task may be compared with the existing tasks in the training data set and added when the task diversity score has a minimum amount of diversity compared to each of the training data tasks already in the training set. This may be evaluated, for example, by comparing the one or more task diversity scores for the additional task (evaluated against the existing training tasks) with a threshold and adding the task to the training data set when the task diversity scores are all above the threshold. That is, the additional task adds a minimum amount of task diversity as evaluated relative to each task in the training data.

In some embodiments, the tasks for the domain may be determined by a task generation algorithm, such as the process discussed below related to disentangled latents. The task generation algorithm may, for example, aim to generate a set of tasks for data samples of the domain with an unsupervised process that does not require pre-existing labels for the domain. The task diversity score may also be used to select a set of tasks for training the meta-learning model by evaluating tasks generated by a task generation algorithm to select, modify, or otherwise affect the task generation algorithm for the tasks used to train the meta-learning model. For example, in some embodiments, the task generation algorithm may be configured to generate a dynamic number of tasks, for example with an aim of generating diverse tasks. In some embodiments, these task generation algorithms may not have a well-defined number of tasks to generate. As tasks are added to the training data set, the task diversity score may be evaluated for sequential tasks to determine whether to generate additional tasks, such that when the task diversity score relative to prior tasks is below a threshold, the task generation algorithm may be stopped.

As another example, a task diversity score may be used to affect the training tasks by affecting the task generation algorithm used for the training tasks. This may include, for example, selecting a particular task generation algorithm (e.g., comparing possible task generation algorithms) or modifying parameters or other aspects of a task generation algorithm. Each task generation algorithm (or varying parameters of a particular task generation algorithm) may yield associated sets of training tasks. For example, a first task generation algorithm may generate an associated first training task set, and a second task generation algorithm may generate an associated second training task set. The first task generation algorithm and second task generation algorithm may be different methodologies, or a similar methodology with differing task generation parameters.

The tasks within each first training task set and the second training task set may be compared with one another to determine task diversity scores of the training tasks within each training task set. For example, the task diversity score for each training task set may be determined as an average of the task diversity scores evaluated for each pair of tasks in the training task set. The training task set used for training the meta-learning model may then be selected based on the task diversity score for the training tasks or may be used to select a task generation algorithm for generating the tasks. In one example, the training task set having a higher task diversity score may be selected as the preferred training task set. As such, in general, training task sets that also have higher task diversity may be preferred. However, it may also be preferred to maximize the number of generated tasks while also maintaining task diversity, such that the selected training task set may be based on a combined score that includes the task diversity score in addition to the number of training tasks in the training task set.

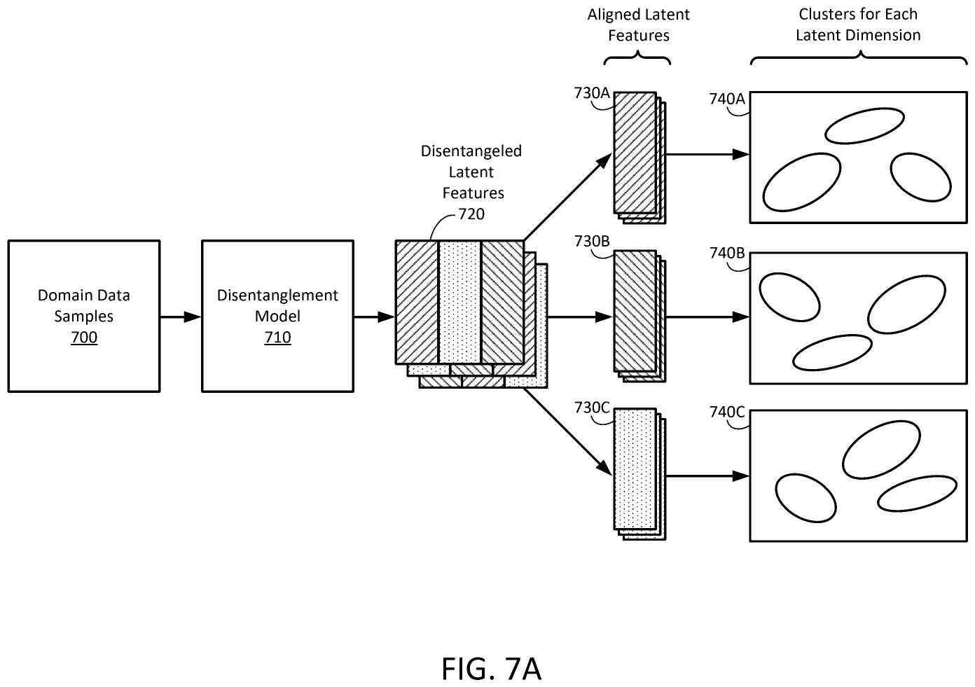

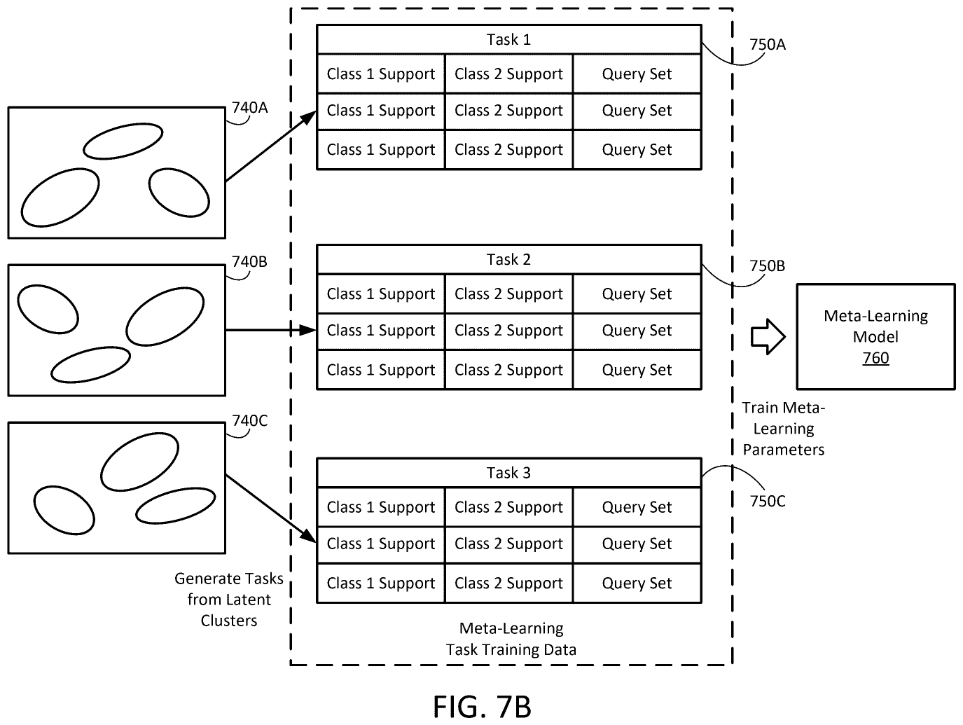

FIGS. 7A-B show a dataflow for generating a diverse set of tasks for training a meta-learning model 760, according to one or more embodiments. The dataflow shown in FIG. 7 may be processed in various embodiments by component of a system training a meta-learning model, such as a model training module 105 as discussed above. Initially, a set of domain data samples 700 forms a set of data samples that may be used for training the meta-learning model. The data samples may include data samples from various data sets and may include data samples that have labels for other purposes. As such, the domain data samples 700 may generally include data samples that may vary in many different characteristics. Although the data samples may include task labels from the originating data sets, diverse tasks are generated for the data samples and automatically enables the data samples to present highly diverse tasks for training a meta-learning model.

To obtain diverse tasks for the domain data samples 700, disentangled latent features 720 are extracted from the domain data samples 700 using a disentanglement model 710. The disentanglement model 710 learns to extract the set of disentangled latent features 720 in which each of the disentangled latent features represents an independent aspect of the domain space. That is, the disentanglement model 710 outputs disentangled latent features 720, such that each latent feature is “disentangled” from other latent features and represents an independent aspect in which the data domain varies. While various dimensions of the input space of the domain may typically include many dimensions that have high correlation, the dimensions of the disentangled latent features 720 are intended to vary independently from one another.

The particular architecture of the disentanglement model 710 varies in different embodiments and may include, for example, variational autoencoders (VAEs), generative adversarial networks (GANs), factorized diffusion autoencoder, a latent slot diffusion model, and other types of models that capture underlying factors of variation in the input domain. The disentanglement model 710 may be trained on data samples of the domain (e.g., the domain data samples 700) to identify latent aspects of variation of the domain.

In some circumstances, the disentanglement model 710 may generate latent feature values that are not aligned between different data samples. For example, for some disentanglement model architectures, the disentanglement model may include stochastic elements or apply attention masks over input data samples, such that resulting features may be aligned by aligning the attention masks. As such, in some embodiments, the latent features are aligned to ensure that the same semantic concept across data samples is represented in the same latent feature.

Each of the aligned latent features 730A-C thus represents a disentangled latent feature that is expected to independently vary relative to the other latent features. As such, data samples may have varying values associated with each latent feature that are expected to be independent relative to other latent features. As such, each type of latent feature may represent a highly “diverse” characterization of the domain. To obtain high diversity tasks based on the disentangled latent features 720, the domain data samples 700 are clustered for each latent feature, such that the data sample values of each latent feature may represent different ways to partition the data domain. As such, the data samples for a first latent feature 730A are clustered into clusters 740A based on latent feature values of the data samples in the first latent feature 730A. Similarly, feature values for the second latent feature 730B are used to cluster the data samples to clusters 740B, and feature values for the third latent feature 730C are used to cluster the data samples to third clusters 740C. The different clusters of the data samples thus represent different ways to partition or group the data samples according to the different disentangled latent features of the domain. Each cluster may represent a “class” for a “task” associated with the latent feature, such that the latent feature types become pseudo “tasks” for the meta-learning model to learn. Similarly, as each data sample may be assigned to a cluster for each of the latent feature types, each data sample may have a corresponding class for the “task” of predicting that latent feature.

The number of clusters may be determined in various ways in different embodiments and may be based on characteristics of the feature values of the data samples for the respective latent feature. In addition, the number of clusters may also differ from the number of classes that may be used as class supports for the meta-learning model. Likewise, the number of clusters for each latent feature may also vary (based, e.g., on characteristics of the distributions of feature values for that latent feature). The data samples may be clustered according to any suitable clustering algorithm, such as k-means clustering.

FIG. 7B illustrates generating meta-learning task training data based on the latent feature clusters 740A-C. Each set of clusters 740 thus represents a set of classes for the latent feature that may represent distinct “tasks” that may be used as training data labels for the meta-learning model.

To construct training tasks 750A-C for the meta-learning model 760, data samples are selected from the respective clusters 740A-C. Particularly, the class supports may be determined by selecting (e.g., randomly) a cluster to represent each class for the training task and populating the class supports and query set with data samples from the selected clusters. For example, to determine a training task 750A for a first latent feature, a first cluster may be selected for class 1 and a second cluster for class 2, with respective data samples selected to construct a training input. Different training tasks for the same latent feature may use different clusters for populating the classes of the training tasks. For example, a first training task 750A may populate class 1 supports from a first cluster 740A, while a second training task 750B may populate class 1 supports from a second cluster 740B, and a third training task 750C may populate class 1 supports from a third cluster 740C. Similarly, training tasks 750B may be generated for a second latent vector by selecting class supports and queries from clusters 740B. Training tasks 750C may be generated similarly from clusters 740C. The training tasks 750 may then be used as a set of diverse “tasks” for training the meta-learning model 760.

As different dimensions within the disentangled representation depict distinct aspects of the input data, the sets of self-supervised tasks constructed from disentangled dimensions are naturally diversified, requiring distinct decision rules to solve. When using these tasks for meta-learning, the model can digest each factor of variation within the data and therefore learns to adapt to unseen few-shot tasks regardless of their contexts, natures, and meanings.

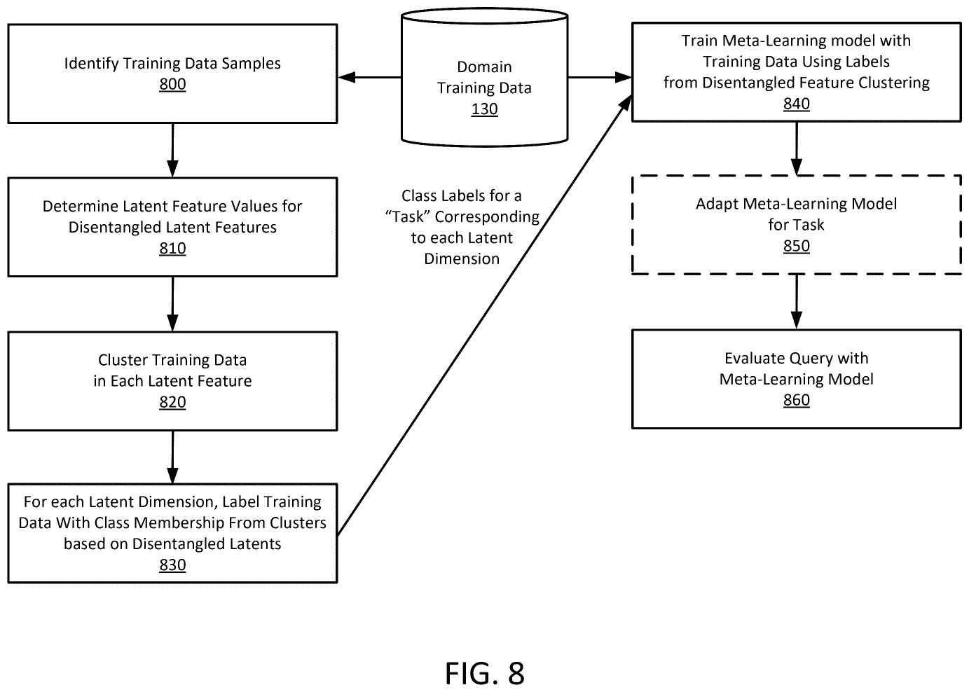

FIG. 8 shows an example method for training and applying a meta-learning model, according to one or more embodiments. This method may be performed, for example, by various components of the meta-learning system 100. For example, the training data generation, training, and adaptation may be performed by the model training module 105 and model adaptation module 110, and queries with new data may be performed by the query module 115 as discussed above.

Initially, a set of training data samples from domain training data 130 are identified 800 for use in training the meta-learning model. The training data samples for the domain may represent a group of diverse data samples for determination of diverse tasks for training the meta-learning model. Although some data samples may have existing labels for various tasks, the data samples may be processed to determine diverse tasks for training the meta-learning model.

Next, the latent feature values are determined 810 for the data samples to determine the latent feature values corresponding to a set of disentangled latent features. The latent feature values may be determined 810 by applying the data samples to a disentanglement model (e.g., a trained encoder) that outputs feature values for the data samples that are disentangled from one another and represent independent aspects of variation across the various domain data samples. In some embodiments, the disentanglement model may be trained based on the identified data samples.

Each disentangled latent feature is then used to represent a separate “task” that may be learned by the meta-learning model by clustering 820 the data samples for the respective latent feature according to the latent feature values of the data samples. The clusters indicate, within each latent feature, distinctions across different data samples and “natural” classes that may be identifiable from the data samples. The clusters may then be used as class labels for labeling 830 the data samples for “tasks” corresponding to each latent feature.

The task labels may then be used to construct training tasks to train 840 the meta-learning model with training data of tasks using labels from the disentangled feature clustering. This training may thus result in a meta-learning model trained with diverse tasks that may be further adapted 850 and applied to evaluate 860 queries for a new task as discussed above.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for improving meta-learning model performance, comprising:
one or more processors configured to execute instructions; and
one or more computer-readable media containing instructions executable by the processors for:
identifying a set of training data samples for a domain;
determining latent feature values for a plurality of disentangled latent features for each training data sample in the set of training data samples;
for each latent feature of the plurality of latent features:
clustering the plurality of training data samples based on the respective latent feature values;
generating one or more training tasks including a plurality of support data samples and one or more queries from the set of training data samples having labels based on the clustering for the latent feature;
adding the one or more training tasks to a plurality of training tasks; and
training parameters of a meta-learning model for the domain based on the plurality of training tasks.

2. The system of claim 1, wherein the training data samples do not include task training labels.

3. The system of claim 1, wherein the instructions are further executable for adapting the meta-learning model for the domain to an inference task based on a set of inference task training data.

4. The system of claim 1, wherein the instructions are further executable for applying the meta-learning model to an inference task.

5. The system of claim 1, wherein determining the latent feature values comprises applying the training data sample to a disentanglement model.

6. The system of claim 5, wherein the disentanglement model is trained to generate the plurality of disentangled latent features based on the set of training data samples.

7. The system of claim 1, wherein the instructions are further executable for aligning the plurality of disentangled latent features before clustering the plurality of training data samples.

8. The system of claim 1, wherein the domain is images or tabular data.

9. A computer-implemented method for improving meta-learning model performance, comprising:
identifying a set of training data samples for a domain;
determining latent feature values for a plurality of disentangled latent features for each training data sample in the set of training data samples;
for each latent feature of the plurality of latent features:
clustering the plurality of training data samples based on the respective latent feature values;
generating one or more training tasks including a plurality of support data samples and one or more queries from the set of training data samples having labels based on the clustering for the latent feature;
adding the one or more training tasks to a plurality of training tasks; and
training parameters of a meta-learning model for the domain based on the plurality of training tasks.

10. The method of claim 9, wherein the training data samples do not include task training labels.

11. The method of claim 9, further comprising adapting the meta-learning model for the domain to an inference task based on a set of inference task training data.

12. The method of claim 9, further comprising applying the meta-learning model to an inference task.

13. The method of claim 9, wherein determining the latent feature values comprises applying the training data sample to a disentanglement model.

14. The method of claim 13, wherein the disentanglement model is trained to generate the plurality of disentangled latent features based on the set of training data samples.

15. The method of claim 9, further comprising aligning the plurality of disentangled latent features before clustering the plurality of training data samples.

16. The method of claim 9, wherein the domain is images or tabular data.

17. A non-transitory computer-readable medium for improving meta-learning model performance, the non-transitory computer-readable medium comprising instructions executable by a processor for:
identifying a set of training data samples for a domain;
determining latent feature values for a plurality of disentangled latent features for each training data sample in the set of training data samples;
for each latent feature of the plurality of latent features:
clustering the plurality of training data samples based on the respective latent feature values;
generating one or more training tasks including a plurality of support data samples and one or more queries from the set of training data samples having labels based on the clustering for the latent feature;
adding the one or more training tasks to a plurality of training tasks; and
training parameters of a meta-learning model for the domain based on the plurality of training tasks.

18. The non-transitory computer-readable medium of claim 17, wherein the training data samples do not include task training labels.

19. The non-transitory computer-readable medium of claim 17, wherein the instructions are further executable for adapting the meta-learning model for the domain to an inference task based on a set of inference task training data.

20. The non-transitory computer-readable medium of claim 17, wherein the instructions are further executable for applying the meta-learning model to an inference task.
